(19) United States
(12) Patent Application Publication
(10) Pub. No.: US 2024/0282470 A1
(43) Pub. Date: Aug. 22, 2024

(54) REACTIONS USING FACILITATORS AND MODERATORS

(71) Applicant: K-Orbital LLC, Aurora, CO (US)

(72) Inventors: Kenneth N. SWARTZ, Lakewood, CO (US); Gary J. RODRIGUEZ, Parker, CO (US)

(73) Assignee: K-Orbital LLC, Aurorra, CO (US)

(21) Appl. No.: 18/649,142

(22) Filed: Apr. 29, 2024

Related U.S. Application Data
(63) Continuation of application No. 17/336,204, filed on Jun. 1, 2021.
Application No. 17/336,204 is a continuation-in-part of application No. 15/334,239, filed on Oct. 25, 2016, now abandoned.
(60) Provisional application No. 62/246,396, filed on Oct. 26, 2015.

(51) Int. Cl. G21B 3/00; G21G 7/00

(52) U.S. Cl. CPC G21B 3/00; G21G 7/00

(57) ABSTRACT

A method implements reactions using facilitators and moderators. The method includes filling a reaction vessel with a moderator gas and a facilitator gas. The method further includes triggering a spark in the reaction vessel at a spark gap between a first electrode and a second electrode to generate a product from the facilitator gas and a reactant. The method includes retrieving the product from the reaction vessel through an opening of the reaction vessel.

### CROSS REFERENCE TO PRIOR APPLICATIONS

This application is a continuation of U.S. application Ser. No. 17/336,204, filed Jun. 1, 2021, which is incorporated by reference herein. U.S. application Ser. No. 17/336,204 is a continuation in part of U.S. application Ser. No. 15/334,239, filed Oct. 25, 2016, which is incorporated by reference herein. U.S. application Ser. No. 15/334,239 claims the benefit of U.S. Provisional Application 62/246,396, filed Oct. 26, 2015, which is incorporated by reference herein.

### BACKGROUND

Nuclear reactions can occur via either fusion or fission. A widespread belief is that fusion only occurs at extreme temperatures. The fusion process above iron is endothermic because less energy is produced by the reaction than is needed to maintain the temperature and supporting magnetic fields. Fission may occur at low temperatures and pressures and may be highly exothermic. Fission may evolve highly radioactive species that can have half-lives of thousands of years. The nuclei needed for fission are also a limited resource.

Reactions with nuclear transmutation at low temperatures and varying pressures without the evolution of radioactive species may be possible. A challenge is to provide an apparatus that may provide for such reactions.

### SUMMARY

In general, in one or more aspects, the disclosure relates to a method that implements reactions using facilitators and moderators. The method includes filling a reaction vessel with a moderator gas and a facilitator gas. The method further includes triggering a spark in the reaction vessel at a spark gap between a first electrode and a second electrode to generate a product from the facilitator gas and a reactant. The method includes retrieving the product from the reaction vessel through an opening of the reaction vessel.

In general, in one or more aspects, the disclosure relates to an apparatus that implements reactions using facilitators and moderators. The apparatus includes a reaction vessel filled with a moderator gas and a facilitator gas. The apparatus further includes a spark gap in the reaction vessel. The spark gap is between a first electrode and a second electrode and, within the spark gap, a spark may be triggered to generate a product from the facilitator gas and a reactant. The apparatus further includes an opening of the reaction vessel. The product is retrievable through the opening.

In general, in one or more aspects, the disclosure relates to a system that implements reactions using facilitators and moderators. The system includes a reaction vessel. The system further includes a spark gap in the reaction vessel, a direct current voltage source, and an opening of the reaction vessel. The reaction vessel may be filled with a moderator gas and a facilitator gas. The spark gap may be in the reaction vessel. The spark gap is between a first electrode and a second electrode and, within the spark gap, a spark is triggered with the direct current voltage source to generate a product from the facilitator gas and a reactant. The product may be retrievable through the opening.

Other aspects of the one or more embodiments may be apparent from the following description and the appended claims.

### BRIEF DESCRIPTION OF DRAWINGS

FIG. 1 shows a diagram in accordance with one or more embodiments of the disclosure.

FIG. 2 shows a method in accordance with one or more embodiments of the disclosure.

FIG. 3 and FIG. 4 show examples in accordance with one or more embodiments of the disclosure.

Similar elements in the various figures are denoted by similar names and reference numerals. The features and elements described in one figure may extend to similarly named features and elements in different figures.

### DETAILED DESCRIPTION

Embodiments of the disclosure provide systems, apparatuses, and methods for facilitating compound gas reactions using facilitators and moderators for reactions that may include nuclear transmutation. A reaction vessel is filled with a moderator gas and a compound gas. The moderator gas may be a noble gas. The compound gas includes a facilitator that may be combined with another element. For example, the facilitator may include one or more of oxygen, carbon, nitrogen, fluorine, phosphorus, sulfur, chlorine, selenium, bromine, and iodine and may be combined with one or more of hydrogen, deuterium, lithium, beryllium, boron, carbon, sodium, magnesium, calcium, titanium, strontium, and zirconium. Two electrodes are in the reaction vessel separated by a spark gap. A spark triggered between the electrodes in the spark gap generates a product from the compound gas. In an embodiment, the product may have a mass number that is different from the mass number of the facilitator of the compound gas.

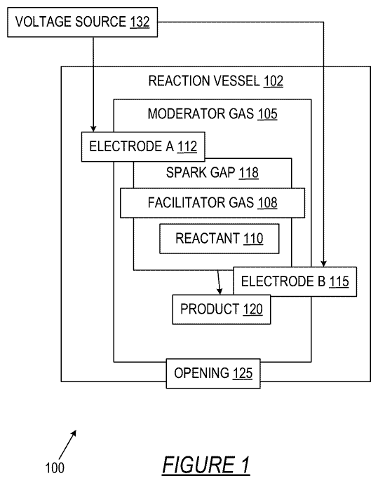

Turning to FIG. 1, the system (100) provides for reactions using facilitators and moderators. The system (100) includes the reaction vessel (102).

The reaction vessel (102) is a piece of chemical engineering equipment to carry out reactions between chemical elements. The reaction vessel (102) is a container to hold chemicals, facilitate chemical reactions, and provide the conditions for a reaction to occur. The reaction vessel (102) may be designed to handle corrosive and non-corrosive fluids and can withstand extreme temperatures and pressures. The reaction vessel (102) may be different sizes and shapes and made from and materials that include glass, stainless steel, plastic, etc.

The moderator gas (105) is a gas within the reaction vessel (102). In an embodiment, the moderator gas (105) may operate to affect the reaction by the concentration of the reactants, the reaction temperature, the reaction mechanism, etc. For example, the reaction of the facilitator gas (108) and the reactant (110) to form the product (120) may not occur without the presence of the moderator gas (105). The moderator gas (105) may include one or more noble gases, including helium, neon, argon, krypton, xenon, and radon. In an embodiment, the volume of noble gas in the reaction vessel (102) to facilitate the reaction may be in the range of 90 to 99 percent by volume or weight to serve as a thermal moderator or physical scaffolding. The moderator gas (105) is not consumed by the process of generating the product (120) from the facilitator gas (108) and the reactant.

The facilitator gas (108) fills a portion of the reaction vessel (102) with the moderator gas (105). In an embodiment, the facilitator gas (108) the volume of the facilitator gas in the reaction vessel (102) may be in the range of one to ten percent. The facilitator gas (108) may enhance the likelihood of a reaction within the reaction vessel (102). In an embodiment, the facilitator gas (108) may include one or more chalcogens, halogens, and reactive nonmetals. For example, the facilitator gas (108) may include oxygen, carbon, nitrogen, fluorine, phosphorus, sulfur, chlorine, selenium, bromine, iodine, etc. In an embodiment, the facilitator may be purified to include one element from the chalcogens, halogens, or reactive nonmetals. When the reaction vessel (102) is activated, the facilitator gas (108) may form highly electronegative ions in an electron-rich plasma.

The reactant (110) includes another chemical element within the reaction vessel (102). In an embodiment, the reactant (110) may react with the facilitator gas (108) to form the product (120). In an embodiment, the reactant may include one or more of hydrogen, alkali metals, alkaline earth metals, lanthanoids, actinoids, transition metals, post-transition metals, and metalloids. For example, the reactant (110) may include hydrogen, lithium, beryllium, boron, carbon, sodium, magnesium, calcium, titanium, strontium, and zirconium.

In an embodiment, the reactant (110) includes an isotope of hydrogen that is combined with the facilitator gas (108). For example, the reactant (110) may include deuterium that is combined with oxygen of the facilitator gas (108) in the form of deuterium oxide, also referred to as heavy water. With deuterium oxide, the product formed from the facilitator gas (108) and the reactant (110) may include one or more chemical elements and isotopes thereof, including fluorine (e.g., fluorine-18), oxygen (e.g., oxygen-18, neon (neon-20), etc.

In an embodiment, the reactant (110) may be formed as part of one of the electrodes A (112) and B (115). For example, the reactant (110) may be formed as part of the electrode A (112) out of palladium and the facilitator gas (108) may include oxygen. The reaction of palladium with oxygen may generate xenon. As another example, the reactant (110) may be formed as part of the electrode A (112) out of platinum and the facilitator gas (108) may include oxygen, which may react to generate radon.

The electrodes A (112) and B (115) are conductive components used to facilitate reactions in the reaction vessel (102). The electrodes A (112) and B (115) are electronic terminals that facilitate an electric field for the reactions to occur. One of the electrodes A (112) and B (115) may be an anode and the other may be a cathode. In an embodiment, negative charges flow from the cathode and to the anode through the spark gap (118). The material of the electrodes may affect the efficiency and selectivity of the reaction. For example, certain materials may be chosen for electrical conductivity, corrosion resistance, or ability to catalyze specific reactions.

The spark gap (118) is a gap between the electrodes A (112) and B (115). The spark gap (118) is used to create a spark or an electrical discharge between the electrodes A (112) and B (115). The space forming the spark gap (118) is filled with the moderator gas (105) and the facilitator gas (108). An electrical voltage from the direct current voltage source (132) is applied across the electrodes A (112) and B (115) to create a spark in the spark gap (118). In an embodiment, the length of the spark gap (118) may have a length within 10 percent of 0.25 inches between the electrodes A (112) and B (115).

The product (120) is a set of chemical elements generated in the reaction vessel (102). In an embodiment, the product (120) is a generated from the facilitator gas (108) combining with the reactant (110).

The opening (125) is a part of the reaction vessel (102). The opening (125) may be used to retrieve the product (120) from within the reaction vessel (102) after the product (120) is formed.

In an embodiment, the opening (125) may be in the form of a vent through which the product (125) may be retrieved. As an example, with deuterium oxide forming the facilitator gas (108) and the reactant (110), the vent may be used to retrieve the product (120), which may include fluorine-18, oxygen-18, and neon-20.

In an embodiment, the opening (125) facilitate removal of one or more of the electrodes A (112) and B (115) when the product (120) forms onto the one or more of the electrodes A (112) and B (115). For example, when the electrode A (112) includes strontium as the reactant (110) and the facilitator gas (108) includes oxygen, the product (120) may include palladium, which may form on or within the electrode A (112).

The voltage source (132) is a device that provides a voltage to the reaction vessel (102). The voltage source (132) may include a power supply that provides a direct current (DC) voltage to the reaction vessel (102), which is used to generate a plasma or spark within the reaction vessel (102) at the spark gap (118). The voltage used may range from 2,000 to 1,000,000 volts. As an example, with deuterium oxide forming the facilitator gas (108) and the reactant (110), the voltage used may be 5,000 volts.

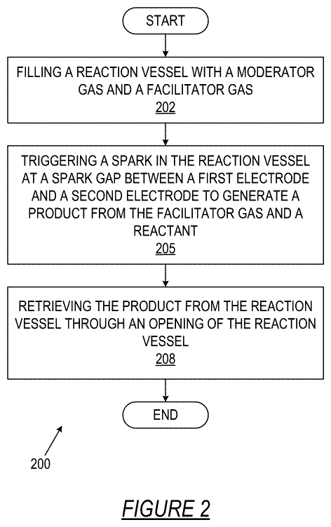

Turning to FIG. 2, the process (200) may be used to perform reactions using facilitators and moderators. The process (200) may include multiple steps (e.g., the Steps 202 through 208) that may be performed with the components described in the other figures, including the components of the system (100) of FIG. 1.

The Step 202 includes filling a reaction vessel with a moderator gas and a facilitator gas. The reaction vessel may be filled with the moderator gas and the facilitator gas through an opening of the reaction vessel. The ratio between the facilitator gas and the monitor gas may be controlled so that the moderator gas may fill 90 to 99 percent of the reaction vessel by weight or volume leaving the facilitator gas to fill one to 10 percent of the reaction vessel by weight or volume, respectively.

The Step 205 includes triggering a spark in the reaction vessel at a spark gap between a first electrode and a second electrode to generate a product from the facilitator gas and a reactant. The spark may be triggered with a voltage from a power supply. In an embodiment, the voltage may be provided as a direct current voltage, which may be in the range of 2,000 to 1,000,000 volts.

The Step 208 includes retrieving the product from the reaction vessel through an opening of the reaction vessel. When the product is a gas, your product may be evacuated through the opening formed as a vent in the reaction vessel. When the product forms on one of the electrodes, the opening may be opened after the reaction is completed to remove the electrode from the interior of the reaction vessel.

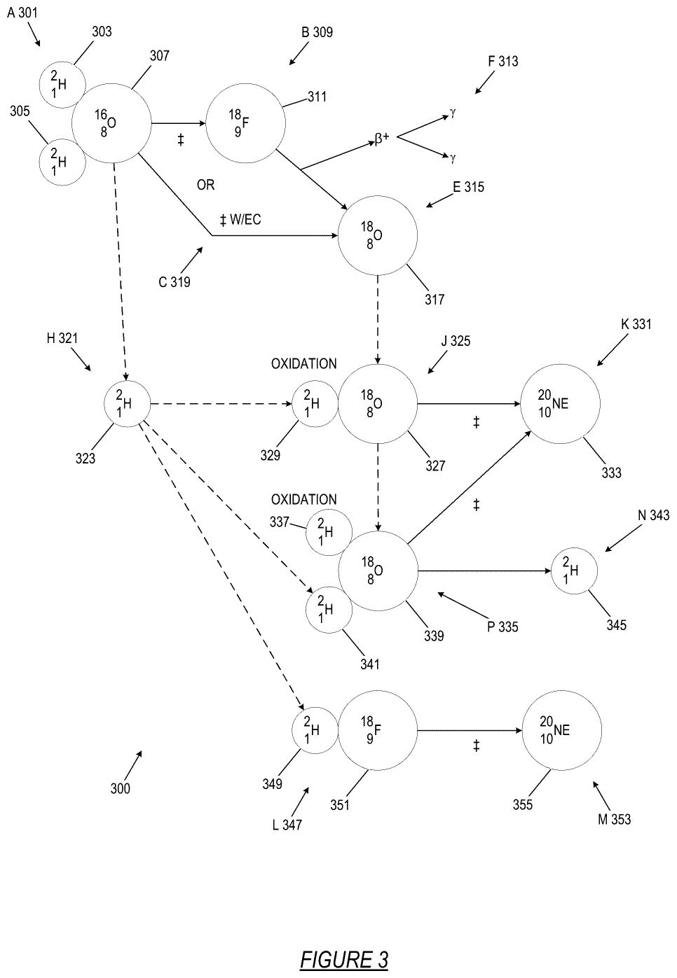

Turning to FIG. 3, the graph (300) shows the reactions of facilitators with reactants that may occur in a reaction vessel. A moderator is present but does not react and is not shown. The graph represents chemical elements with nodes and transitions with edges. The double dagger symbol (“‡”) for a transition (e.g., the transition between nodes A (301) and B (309)) indicates a fusion reaction may take place. The graph (300) represents multiple chemical reactions that may continuously occur. The individual atoms and molecules at the nodes of the graph (300) may represent multiple atoms and molecules in a reaction vessel.

Node A (301) represents deuterium oxide molecules formed with the oxygen-16 atom (307) and the hydrogen-2 (deuterium) atoms (303) and (305). Node A (301) may transition to nodes B (309) and H (321) or to nodes E (315) and H (321).

Node A (301) may transition to nodes B (309) and H (321) by fusion of one of the hydrogen-2 atoms (303) and (305) with the oxygen-16 atom (307) to form the fluorine-18 atom (311) (node B (309)) and releasing the other one of the hydrogen-2 atoms (303) and (305) (node H (321)). The transition from node A (301) to nodes B (309) and H (321) is represented by the equation below.

₁²H₂₈¹⁶O→₉¹⁸F+₁²H (1)

Node B (309) represents the fluorine-18 atom (309) and may transition to nodes E (315) and F (313) by a positron emission from the fluorine-18 atom (309) to form the oxygen-18 atom (317) (node E (315)). The emitted positron may encounter and annihilate with an electron (not shown) to release the gamma rays at node F (313). The transition from node B (309) to nodes E (315) and F (313) is represented by the equations below.

₉¹⁸F→₁⁰β+₈¹⁸O (2)

₁⁰β+₋₁⁰e→₀⁰γ+₀⁰γ (3)

Node A (301) may transition to nodes E (315) and H (321) by fusion of one of the hydrogen-2 atoms (303) and (305) with the oxygen-16 atom (307) with electron capture to form the oxygen-18 atom (317) (node E (315)) and releasing the other one of the hydrogen-2 atoms (303) and (305) (node H (321)). The transition from node A (301) to nodes E (315) and H (321) is represented by the equation below.

₁²H₂₈¹⁶O→₈¹⁸O+₁²H (4)

Node E (315) represents the oxygen-18 atom (317). Node E (315) with the node H (321) may transition to the node J (325) by an oxidation reaction to combine the oxygen-18 atom (317) with the hydrogen-2 atom (323) to form the hydroxyl molecule with the hydrogen-2 atom (329) and the oxygen-18 atom (327). The transition from nodes E (315) and H (321) to node J (325) is represented by the equation below.

₈¹⁸O+₁²H→₁²H₈¹⁸O (5)

Node H (321) shows the deuterium atom (323), which may have been released from a deuterium oxide molecule, e.g., from node A (301). The transition of the deuterium atom (323) may involve a reduction oxidation reaction to form the molecules at nodes J (325), P (335), and L (347). The deuterium atom (323) may transition from node H (321) (with node E (315)) to node J (325) (as shown in equation 5 above), transition from node H (321) (with node J (325)) to node P (335) (as shown in equation 8 below), and may transition from node H (321) to node L (347).

Node H (321) may transition to node L (347) by an oxidation reaction to combine the hydrogen-2 atom (323) with a fluorine-18 atom (e.g., from node B (309)) to form the hydrogen fluoride molecule with the hydrogen-2 atom (349) and the fluorine-18 atom (351). The transition from node H (321) to node L (347) is represented by the equation below.

₁²H+₉¹⁸F→₁²H₉¹⁸F (6)

Node J (325) shows the hydroxyl molecule formed from the oxygen-18 atom (327) and the hydrogen-2 atom (329). Node J (325) may transition to node K (331) and to node P (335).

Node J (325) may transition to node K (331) by fusion of the hydrogen-2 atom (329) with the oxygen-18 atom (327) to form the neon-20 atom (333). The transition from node J (325) to K (331) is represented by the equation below. Since the hydrogen-2 atom (329) and the oxygen-18 atom (327) include a total of nine protons and 11 neutrons, beta decay may occur as a part of the transition from node J (325) to node K (331) to convert one of the neutrons to a proton.

₁²H₈¹⁸O→₁₀²⁰Ne (7)

Node J (325) with node H (321) may transition to node P (335) by combining the hydroxyl molecule having the oxygen-18 atom (327) (node J (325)) and the hydrogen-2 atom (329) (node J (325)) with the hydrogen-2 atom (323) (node H (321)) to form the heavy water molecule having the hydrogen-2 atoms (337) and (341) and the oxygen-18 atom (339). The transition from nodes J (325) and H (321) to node P (335) is represented by the equation below.

₁²H₈¹⁸O+₁²H→₁²H₂₈¹⁸O (8)

Node P (335) represents a heavy water molecule having the hydrogen-2 atoms (337) and (341) and the oxygen-18 atom (339). Each of the hydrogen and oxygen atoms at node P (335) include an extra neutron. Node P (335) may transition to nodes K (331) and N (343) by fusion of one of the hydrogen-2 atoms (337) and (341) with the oxygen-18 atom (339) to form the fluorine-20 atom (333) (node K (331)) and releasing the other one of the hydrogen-2 atoms (337) and (341) (node N (343)). The transition from node P (335) to nodes K (331) and N (343) is represented by the equation below.

₁²H₂₈¹⁸O→₉²⁰F+₁²H (9)

Node N (343) represents the hydrogen-2 atom (345). The hydrogen-2 atom (345) may be released from the water molecule of node P (335) and then used additional reactions (e.g., the reactions from node H (321) to nodes J (325), P (335), or L (347)).

Node L (347) represents the hydrogen fluoride molecule with the hydrogen-2 atom (349) and the fluorine-18 atom (351). Node L (347) may transition to Node M (353) by fusion of the hydrogen-2 atom (349) with the fluorine-18 atom (351) to form the neon-20 atom (355) (node M (353)). The transition from node L (347) to node M (353) is represented by the equation below.

₁²H₉¹⁸F→₁₀²⁰Ne (10)

Node M (353) represents the neon-20 atom (355). The neon-20 atom (355) may be formed from the hydrogen-2 atom (349) and the fluorine-18 atom (351) from node L (347).

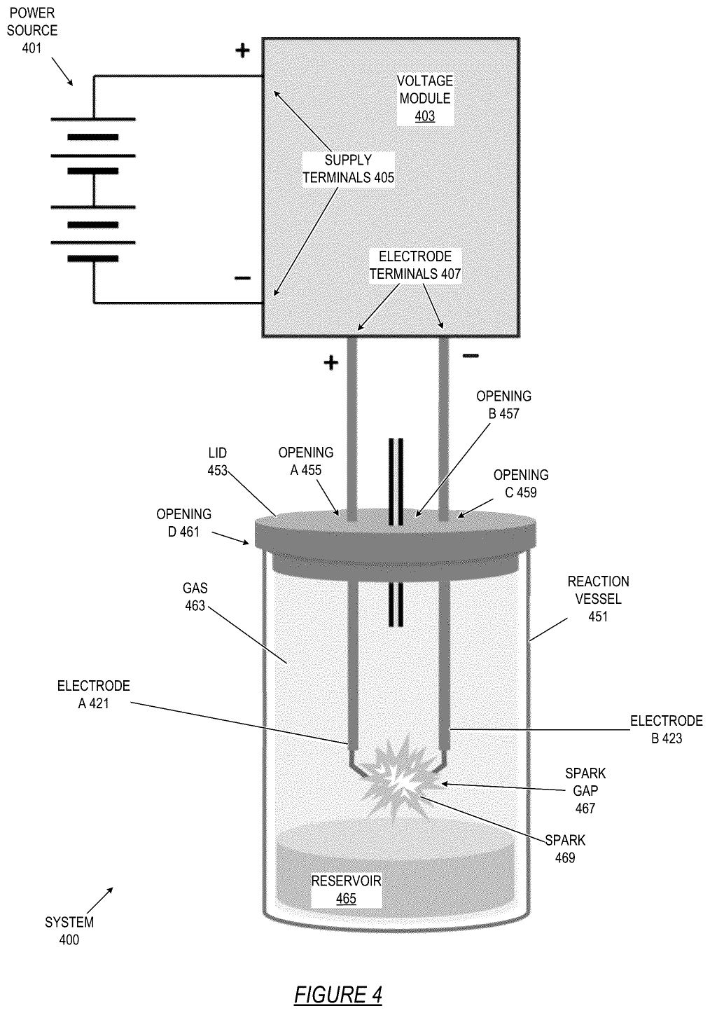

Turning to FIG. 4, the system (400) may facilitate reactions with facilitators and moderators.

The power source (401) provides electrical power to the system (400). The power provided by the power source (401) may be direct current. In an embodiment, the power source (401) is in the form of one or more batteries that provide direct current power. In an embodiment, the power source (401) may be an electrical outlet that provides alternating current power.

The voltage module (403) converts power from the power source (401) to the power used within the reaction vessel (451). For example, the voltage module (403) may step the voltage up to be above the breakdown voltage of the spark gap (467). In an embodiment, where the power source (401) provides alternating current power, the voltage module (403) may convert the alternating current power to direct current power. The voltage module (403) receives power from the power source (401) with the supply terminals (405) and transmits power to the electrodes A (421) and B (423) with the electrode terminals (407).

The supply terminals (405) are terminals of the voltage module (403) to receive power from the power source (401). The supply terminals (405) include a positive supply terminal and a negative supply terminal that are respectively connected to the positive and negative ends of the power source (401).

The electrode terminals (407) are terminals of the voltage module (403) that transmit power to the reaction vessel (451) using the electrodes A (421) and B (423). The electric terminals (407) include positive and negative electrode terminals. In and embodiment, the positive electrode terminal is connected to the electrode A (421) and the negative electrode terminal is connected to the electrode B (423).

The electrodes A (421) and B (423) conduct electrical power through the gas (463) within the reaction vessel (451). In an embodiment, the electrode A (421) is connected to the positive electrode terminal of the electrode terminals (407) to operate as an anode and the electrode B (423) is connected to the negative electrode terminal of the electrode terminals (407) to operate as a cathode. The anode (electrode A (421)) receives negative electrical charges or ions from the cathode (electrode B (423)). The electrodes A (421) and B (423) are inserted into the reaction vessel (451) respectively through the openings A (455) and C (459).

The reaction vessel (451) contains the reactions facilitated through the system (400). The interior of the reaction vessel (451), referred to as a reaction chamber, contains the gas (463) with the reservoir (465) and the electrodes A (421) and B (423). The reaction vessel (451) includes the lid (453) along with the openings A (455), B (457), C (459), and D (461).

The lid (453) is a part of the reaction vessel (451). The lid (453) covers the opening D (451).

The openings A (455), B (457), C (459), and D (461) our portions of the reaction vessel (451) through which the contents of the reaction vessel (451) may be inserted or removed. As an example, the electrodes A (421) and B (423) may be inserted or removed through the openings A (455) and C (459).

The opening B (457) may be a vent that may be used to control the gas (463) within the reaction vessel (451). As an example, the vent may be used to evacuate the original contents of the reaction vessel (451) after assembly and then add in the moderator gas up to a certain pressure, referred to as the moderator gas pressure. After adding the moderator gas, the facilitator gas may be added to a different pressure, referred to as the facilitator gas pressure. The difference between the moderator gas pressure and the facilitator gas pressure may be used to control the concentration of the facilitator gas with respect to the moderator gas within the reaction vessel (451).

In an embodiment, the vent formed by the opening B (457) may be used to insert a liquid into the reaction vessel (451) to the reservoir (465) (without touching the electrode A (421) and electrode B (423)). The facilitator (e.g., oxygen) and the reactant (e.g., deuterium) may be contained within the liquid (e.g., heavy water). After inserting liquid, the vent of the opening be (457) may then be used to insert the moderator gas to a moderator gas pressure. The moderator gas pressure in conjunction with the vapor pressure for the liquid may be used to control the concentration of the moderator gas and the facilitator gas within the gas (463).

The gas (463) fills the volume of the reaction vessel (451). The gas (463) is present at the spark gap (467) between the electrodes A (421) and B (423). The gas (463) includes a moderator gas and a facilitator gas. The moderator gas may be a noble gas, which may be argon. The facilitator gas includes a facilitator, which may be oxygen.

The reservoir (465) may be a portion of the reaction vessel (451). In certain embodiments, the reservoir (465) may include a liquid that vaporizes to form the facilitator gas within the gas (463). The liquid of the reservoir does not contact the electrode A (421) and electrode B (423).

The spark gap (467) is a gap between the electrode A (421) and electrode B (423). When the voltage provided by the voltage module (403) through the electrodes a (421) and b423 exceeds the breakdown voltage of the gas (463), the spark (469) is generated at the spark gap (467). In an embodiment, the gap may have a length of 0.25 inch (6.4 mm) and support the spark (469) having a voltage of 5,000 volts. Voltages above 10 kV may produce X-rays, which may be undesirable.

The spark (469) is an electrical discharge between the electrodes A (421) and B (423) at the spark gap (467). The spark (469) may trigger reactions between the facilitator and the reactant in the reaction vessel (451).

In an embodiment, the gas (463) may include the facilitator (e.g., oxygen) and the reactant (e.g., deuterium). With oxygen as the facilitator and deuterium as the reactant, the system (400) may be used to generate fluorine and neon as products as described with FIG. 3.

In another embodiment, the gas (463) may include the facilitator (e.g., oxygen) and the reactant may be formed as part of the electrode A (421). For example, one (or both) of the electrode A (421) and electrode B (423) may include strontium as the reactant. With oxygen as the facilitator and strontium as the reactant, the system (400) may be used to generate palladium as the product in accordance with the equation below.

₃₈⁸⁷Sr+₈¹⁶O→₄₆¹⁰⁴Pd (11)

The system (400) may be used for many different reactions using different facilitators, reactants, and moderators. The equations below describe different reactions that may be facilitated with the system (400).

₃⁷Li+₈¹⁶O→₁₁²³Na (12)

₄⁹Be+₈¹⁶O→₁₂²⁵Mg (13)

₅¹¹B+₈¹⁶O→₁₃²⁷Al (14)

₆¹²C+₈¹⁶O→₁₄²⁸Si (15)

₁₁²³Na+₈¹⁶O→₁₉³⁹K (16)

₁₂²⁴Mg+₈¹⁶O→₂₀⁴⁰Ca (17)

₂₀⁴⁰Ca+₈¹⁶O→₂₈⁵⁶Fe (18)

⁴⁷Ti+¹⁶O→⁶³Zn→⁵¹Cr*+ec→⁵¹V (19)

⁵⁰Ti+¹⁶O→⁶⁶Zn (20)

⁵⁰Ti+¹⁶O→⁶⁶Zn→⁶²Ni+α (21)

⁵⁰Ti+¹⁶O→⁶⁶Zn→⁵⁸Fe+α (22)

⁵⁰Ti+¹⁶O→⁶⁶Zn→⁵⁴Cr+3α (23)

₃₈⁸⁷Sr+₈¹⁶O→₄₆¹⁰⁴Pd (24)

₃₈⁸⁷Sr+₈¹⁶O→₄₆¹⁰³Pd+α→₄₄¹⁰¹Ru (25)

₄₀⁹²Zr+₈¹⁶O→₄₈¹⁰⁸Cd+α→₄₆¹⁰⁴Pd (26)

₄₁⁹¹Zr+₈¹⁶O→₄₈¹⁰⁷Cd+α→₄₆¹⁰³Pd+ec→₄₅¹⁰³Rh (27)

¹⁰⁶Pd+¹⁶O→¹²²Xe (28)

¹⁹⁵Pt+¹⁶O→²¹¹Rn (29)

Some of the immediate transmutation products may be unstable, and quickly decay into other products so that the equations may be balanced with emissions of gamma, X-ray, electron capture, β⁺ (positron), α (alpha particle), or other radiation.

Nuclear synthesis reactions may be augmented by the presence of noble gasses, e.g., argon. The noble gases are not included in the equations above (unless a direct product) because, when present as a moderator, the atoms of the noble gas do not participate in the reaction. The noble gases, (helium, neon, argon, krypton, xenon, and radon), may each be candidates for moderators. Similar to a catalyst, the reaction process may not occur or may occur rarely without the presence of a noble gas in the reaction chamber to serve as a thermal moderator or physical scaffolding. The noble gas is not consumed by the process. The concentration of the noble gas dominates the contents of the reaction vessel and may be 90 to 99 percent of the gaseous volume of the reaction vessel.

The moderator in the process may establish a “thermal/pressure buffer” that enables the persistence of interacting molecules and extends bonding and fusing opportunities. In an embodiment, a moderators may provide a spatial (geometric) role, to form a “scaffolding” that aligns, and orients receptors, and inceptors to a self-organizing result, which may be effective at the scales of both chemical and nuclear phenomena.

The facilitator enhances the probability of a reaction. The facilitator may be highly electronegative ions in an electron-rich plasma created at the spark gap. A chemical bond between the facilitator may or may not be present for different embodiments. Physical proximity of the reactant and the facilitator may enhance the reaction process. The process is viable at ambient atmospheres of standard temperature and pressure. The process may be enhanced under elevated pressure or temperatures.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
filling a reaction vessel with a moderator gas and a facilitator gas;
triggering a spark in the reaction vessel at a spark gap between a first electrode and a second electrode to generate a product from the facilitator gas and a reactant; and
retrieving the product from the reaction vessel through an opening of the reaction vessel.

2. The method of claim 1, wherein the product comprises a first element with a first mass number different from a second mass number of a second element of the facilitator and different from a third mass number of a third element of the reactant.

3. The method of claim 1, wherein the facilitator gas comprises one or more of oxygen, carbon, nitrogen, fluorine, phosphorus, sulfur, chlorine, selenium, bromine, and iodine, and wherein the reactant comprises one or more of hydrogen, deuterium, lithium, beryllium, boron, carbon, sodium, magnesium, calcium, titanium, strontium, and zirconium.

4. The method of claim 1, wherein the moderator gas comprises at least one noble gas.

5. The method of claim 1, wherein the facilitator comprises oxygen and the product comprises one or more of oxygen-18, fluorine-18, neon, sodium, magnesium, aluminum, silicon, potassium, calcium, iron, zinc, palladium, and cadmium.

6. The method of claim 1, wherein the facilitator gas comprises the reactant as deuterium oxide prior to generating the product.

7. The method of claim 1, wherein the reaction vessel further comprises a liquid that evaporates to form the facilitator gas, wherein the liquid does not touch the first electrode and does not touch the second electrode.

8. The method of claim 1, wherein the spark gap comprises a length within 10 percent of 0.25 inches between the first electrode and the second electrode.

9. The method of claim 1, wherein the spark is triggered with a voltage applied to the first electrode and the second electrode within a range of 2,000 to 1,000,000 volts.

10. The method of claim 1, wherein the reaction vessel is cylindrically shaped.

11. An apparatus comprising:
a reaction vessel filled with a moderator gas and a facilitator gas;
a spark gap in the reaction vessel, wherein the spark gap is between a first electrode and a second electrode and, within the spark gap, a spark is triggered to generate a product from the facilitator gas and a reactant; and
an opening of the reaction vessel, wherein the product is retrievable through the opening.

12. The apparatus of claim 11, wherein the product comprises a first element with a first mass number different from a second mass number of a second element of the facilitator and different from a third mass number of a third element of the reactant.

13. The apparatus of claim 11, wherein the facilitator gas comprises one or more of oxygen, carbon, nitrogen, fluorine, phosphorus, sulfur, chlorine, selenium, bromine, and iodine, and wherein the reactant comprises one or more of hydrogen, deuterium, lithium, beryllium, boron, carbon, sodium, magnesium, calcium, titanium, strontium, and zirconium.

14. The apparatus of claim 11, wherein the moderator gas comprises at least one noble gas.

15. The apparatus of claim 11, wherein the facilitator comprises oxygen and the product comprises one or more of oxygen-18, fluorine-18, neon, sodium, magnesium, aluminum, silicon, potassium, calcium, iron, zinc, palladium, and cadmium.

16. The apparatus of claim 11, wherein the facilitator gas comprises the reactant as deuterium oxide prior to generating the product.

17. The apparatus of claim 11, wherein the reaction vessel further comprises a liquid that evaporates to form the facilitator gas, wherein the liquid does not touch the first electrode and does not touch the second electrode.

18. The apparatus of claim 11, wherein the spark gap comprises a length within 10 percent of 0.25 inches between the first electrode and the second electrode.

19. The apparatus of claim 11, wherein the spark is triggered with a voltage applied to the first electrode and the second electrode within a range of 2,000 to 1,000,000 volts.

20. A system comprising:
a reaction vessel;
a spark gap in the reaction vessel;
a direct current voltage source; and
an opening of the reaction vessel,
wherein the reaction vessel is filled with a moderator gas and a facilitator gas, wherein the spark gap is in the reaction vessel, wherein the spark gap is between a first electrode and a second electrode and, within the spark gap, a spark is triggered with the direct current voltage source to generate a product from the facilitator gas and a reactant, and
wherein the product is retrievable through the opening.
